(19) United States
(12) Patent Application Publication
(10) Pub. No.: US 2008/0198410 A1
(43) Pub. Date: Aug. 21, 2008

(54) Print Management Device and Print Management Method

(75) Inventor: Ryuji HATTORI, Gifu-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 12/016,846

(22) Filed: Jan. 18, 2008

(30) Foreign Application Priority Data
Feb. 15, 2007 (JP) 2007-034665

(51) Int. Cl. G06F 3/12

(52) U.S. Cl. 358/1.16; 358/1.15

(57) ABSTRACT

A print management device receives printing data and judges whether a digital signature is attached to the printing data. When a digital signature is attached, the device judges whether a public key of the digital signature is stored and permits printing when the public key of the digital signature is stored and information permitting printing is stored.

### CROSS-REFERENCE TO RELATED APPLICATIONS

This application claims priority under 35 U.S.C. 119 to Japanese Patent Application No. 2007-034665, filed on Feb. 15, 2007, which application is hereby incorporated by reference in its entirety.

### BACKGROUND OF THE INVENTION

1. Field of the Invention

The present invention relates to a device and a method for managing prints.

2. Description of the Related Art

A digital signature for detecting falsification of an electric document and certifying the creator is recently being used as a technique taking the place of a conventionally used handwritten signature and seal.

### BRIEF SUMMARY OF THE INVENTION

A data management device for managing data while preserving confidentiality of the data transmitted from a transmitter is known. The data management device includes a memory unit for storing information related to at least the transmitter, the recipient, and the data output destination; an authentication unit for authenticating the transmitter or the recipient based on a public key cryptosystem; a data reception management unit for receiving and managing data from the transmitter; a recipient register unit for registering the recipient as a group using attribute of electronic certificate; a data transmission unit for transmitting data to the data output destination upon request from the recipient; and a management unit for accepting and managing the electronic signature of the transmitter as transmit confirmation and the electronic signature of the recipient as receive confirmation. The data management device transmits data to the data output destination while preserving confidentiality of the data, and the data is output only by the registered recipient at the data output destination.

Conventionally, however, whether or not to execute printing could not be controlled with a simple procedure in the print management device such as printer.

In view of the above problems, the present invention provides a technique that enables only a person authorized in the print management device to execute printing with a simple procedure.

In order to overcome the problems described above, a first aspect of the present invention relates to a print management device including a memory unit for storing in plurals a public key of a signer of a digital signature in correspondence with a setting of whether or not to execute printing based on a print instruction from the signer in correspondence to each other; a transceiver unit for receiving printing data; a printing data verifying unit for judging whether the digital signature is attached to the printing data, whether the public key of the digital signature is stored in the memory unit when the digital signature is attached, and whether printing based on the print instruction from the signer is permitted when the public key of the digital signature is stored in the memory unit; a print control unit for permitting printing of the printing data when judged by the printing data verifying unit that the digital signature is attached to the printing data, the public key of the digital signature is stored in the memory unit, and printing based on the print instruction from the signer is permitted, and not permitting printing in other cases; and a printer unit for printing the printing data given permission to be printed by the print control unit.

Here, “in other cases” includes a case where the digital signature is not attached to the printing data, a case where the public key of the digital signature is not stored in the memory unit, a case where printing based on print instruction from the signer is not permitted, and the like. “Public key of the digital signature is stored in the memory unit” is a case where the digital signature attached to the printing data is decrypted with one of the public keys stored in the memory unit, and the content of the digital signature is legitimate.

According to the invention, only an authorized person can execute printing by registering the public key of the digital signature of the person to be authorized in the memory unit and setting so that printing is permitted in correspondence to the public key in advance. When the person set in such manner executes printing in the print management device, the printing data can be automatically printed without intervention of the user at the print management device by simply attaching the digital signature to the printing data at a terminal such as a personal computer (PC) that transmits printing data to the print management device.

In a second aspect of the present invention, a notifying unit notifies a transmission source of the printing data that printing is not permitted when the print control unit does not permit printing of the printing data.

In a third aspect of the present invention, a display unit displays that printing is not permitted when the print control unit does not permit printing of the printing data.

According to the present invention, only the authorized person is able to print the printing data with a simple procedure.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram of a print management device according to an embodiment of the present invention.

FIG. 2 is a block diagram of a memory unit of the print management device of FIG. 1.

FIG. 3 is a flowchart of operation of the print management device of FIG. 1.

### DETAILED DESCRIPTION OF THE INVENTION

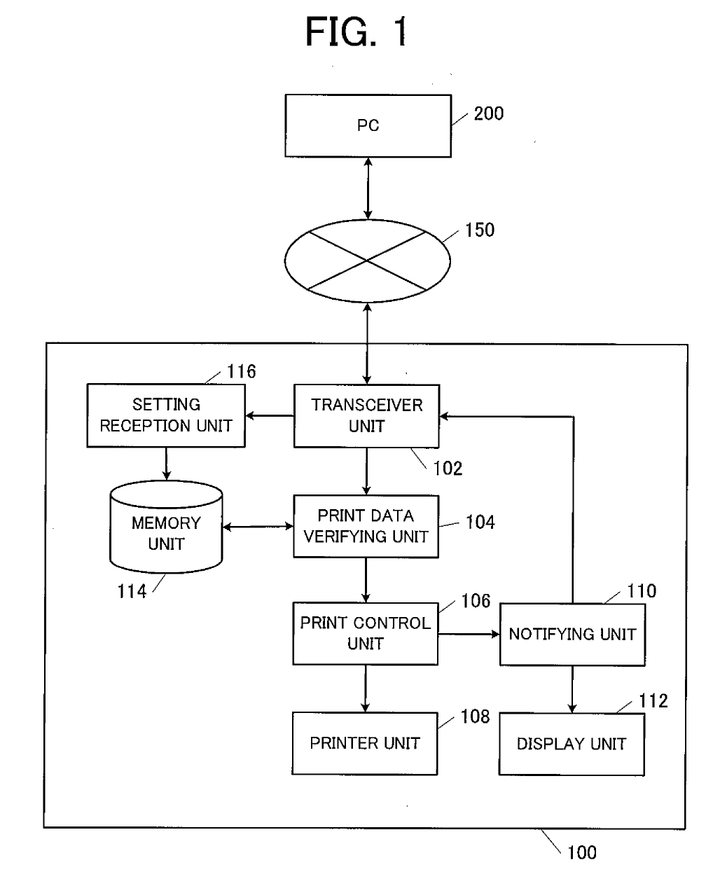

Embodiments of the present invention are now described with reference to the drawings. Similar reference numerals are denoted for similar elements throughout the drawings, and description thereof is appropriately omitted. FIG. 1 is a block diagram of a print management device according to one embodiment of the invention. A print management device 100 is a printer device, a multi function peripheral (MFP) having a facsimile function, or the like. In FIG. 1, portions not related to the essence of the present invention are omitted. The print management device 100 is connected to a terminal such as a PC 200 by way of a network 150 such as the Internet or a Local Area Network (LAN).

The print management device 100 includes a transceiver unit 102, a printing data verifying unit 104, a print control unit 106, a printer unit 108, a notifying unit 110, a display unit 112, a memory unit 114, and a setting reception unit 116.

Each element of the print management device 100 may be a combination of hardware and software centering on a central processing unit (CPU) of a computer, a memory, a program for realizing components of FIG. 1 loaded in the memory, a storage unit such as a hard disc for storing the program, and a network interface. Various methods and devices for realizing each element will be recognized by those skilled in the art. FIG. 1 illustrates blocks as functional units and not their configuration as hardware units.

The transceiver unit 102 receives printing data from the PC 200. The memory unit 114 stores in plurals a public key of a signer of a digital signature in correspondence with a setting of print permission based on a print instruction from the signer. The setting reception unit 116 stores the public key of the digital signature and the setting of print permission in the memory unit 114 in advance.

The setting reception unit 116 receives a setting of the user via an operation unit (not illustrated). The manager of the print management device 100 can set whether or not to permit printing. The setting reception unit 116, for example, authenticates the user, and receives instruction from the authenticated user. The setting reception unit 116 also receives a public key transmitted from another terminal via the transceiver unit 102, and stores the relevant public key in the memory unit 114.

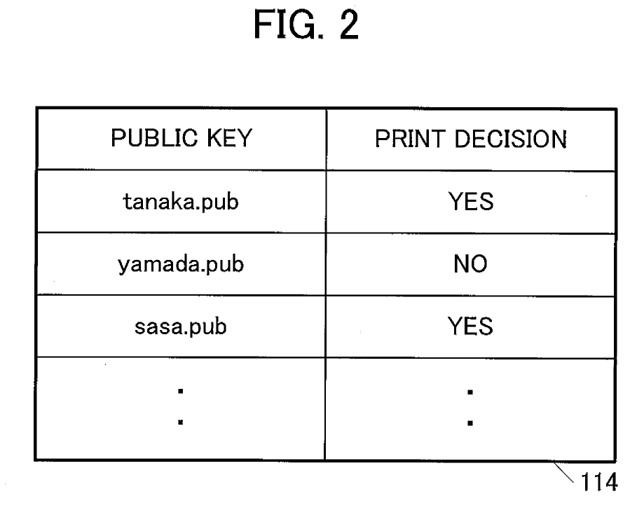

FIG. 2 illustrates one example of a configuration of the memory unit 114. The memory unit 114 includes a public key field and a print decision field. The public key of the signer of the digital signature is stored in the public key field. The setting of print permission is stored in the print decision field. For instance, the public key “tanaka.pub” is given permission to print the printing data. The public key “yamada.pub” is not given permission to print the printing data.

The printing data verifying unit 104 verifies the printing data received by the transceiver unit 102. Specifically, the printing data verifying unit 104 judges whether or not a digital signature is attached to the printing data received by the transceiver unit 102. If the digital signature is attached, the printing data verifying unit 104 judges whether or not the public key of the relevant digital signature is stored in the memory unit 114. If the public key of the digital signature is stored in the memory unit 114, the printing data verifying unit 104 judges whether or not printing based on the print instruction from the signer is permitted.

The print control unit 106 permits printing of the printing data when judged by the printing data verifying unit 104 that the digital signature is attached to the printing data, the public key of the digital signature is stored in the memory unit 114, and printing based on the print instruction from the signer is permitted. The print control unit 106 does not permit printing in other cases. The printer unit 108 prints the printing data which is given permission to be printed by the print control unit 106.

If the print control unit 106 does not permit printing of the printing data, the notifying unit 110 notifies that printing has not been permitted to the PC 200, which is the transmission source of the printing data. If the print control unit 106 does not permit printing of the printing data, the notifying unit 110 may also display such fact on the display unit 112. The display unit 112 may be a liquid crystal display and the like.

The notifying unit 110 may also notify the reason printing was not permitted. If, for example, the user of the PC 200 forgets to attach the digital signature to the printing data although the public key is registered in the memory unit 114, the user can again transmit the printing data attached with the digital signature to the print management device 100 to be printed. If the public key is not registered or if the setting of the print permission is not stored in the memory unit 114, processes can be requested to the manager etc. as needed.

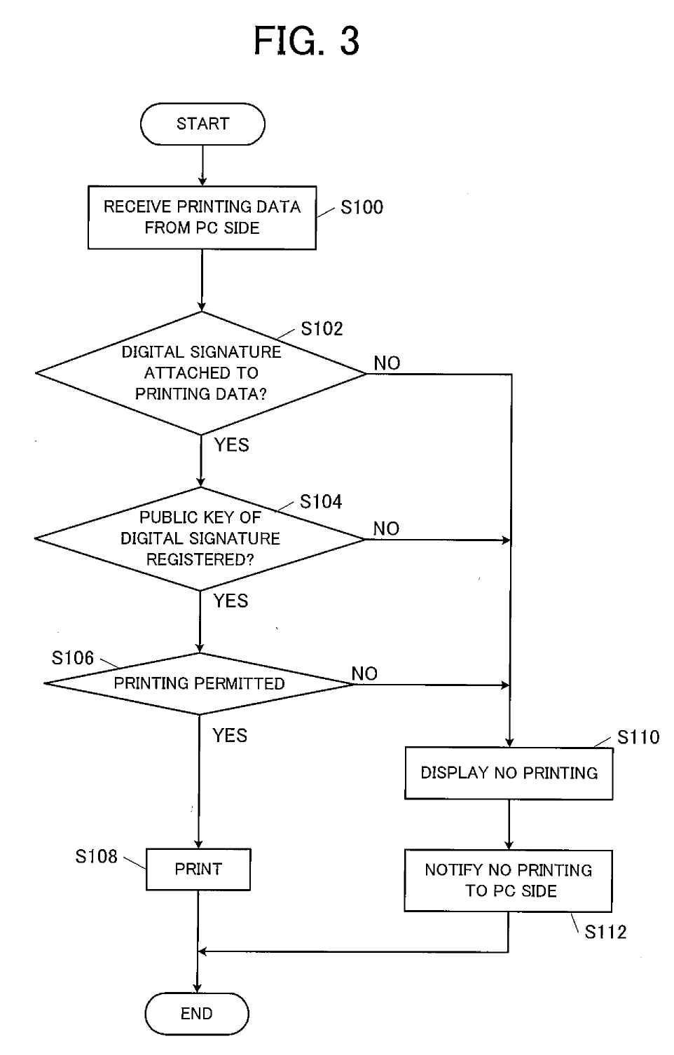

The operation of the print management device 100 configured as above is described below. FIG. 3 is a flowchart illustrating the procedures when the print management device 100 receives the printing data from the PC 200. FIGS. 1 and 2 are also referenced in the following description.

When the transceiver unit 102 receives the printing data (S100), the printing data verifying unit 104 judges whether or not the digital signature is attached to the printing data (S102). If the digital signature is attached (YES in S102), the printing data verifying unit 104 judges whether the public key of the digital signature is registered in the memory unit 114 (S104).

The printing data verifying unit 104 verifies whether the digital signature attached to the printing data can be decrypted with one of the public keys stored in the memory unit 114, and also whether the content is legitimate. If the digital signature is decrypted and the content is legitimate, the printing data verifying unit 104 judges that the public key is registered.

If judged that the public key of the digital signature is registered in the memory unit 114 in step S104 (YES in S104), the printing data verifying unit 104 judges whether or not printing is permitted in correspondence to the public key (S106). If printing is permitted (YES in S106), the print control unit 106 causes the printer unit 108 to print the printing data (S108).

Meanwhile, if the digital signature is not attached in step S102 (No in S102), if the public key of the digital signature is not registered in the memory unit 114 in step 104 (No in S104), or if printing is not permitted in correspondence to the public key (No in S106), the print control unit 106 does not permit printing of the printing data.

In this case, the print control unit 106 notifies the notifying unit 110, and the notifying unit 110 in turn displays the fact that printing is not performed on the display unit 112 (S110). Alternatively, the print control unit 106 notifies that printing is not performed to the PC 200, which is the transmission source of the printing data through the transceiver unit 102 (S112).

As described above, according to the print management device 100 of the present embodiment, only authorized users can execute printing in the print management device 100. In this case, the printing data verifying unit 104 judges whether the public key of the digital signature attached to the printing data is stored in the memory unit 114 and whether print permission is set in correspondence to the public key, and thus whether or not to print the printing data can be judged with the digital signature as the key. Therefore, in the PC 200, authorized users can execute printing in the print management device 100 with a simple operation of attaching a digital signature to the printing data desired to be printed.

While the present invention has been described with respect to embodiments thereof, it will be apparent to those skilled in the art that the disclosed invention may be modified in numerous ways and may assume many embodiments other than those specifically set out and described above. Accordingly, the appended claims cover all modifications that fall within the true spirit and scope of the present invention.

What is claimed is:

1. A print management device comprising:
a memory unit for storing in plurals a public key of a signer of a digital signature in correspondence with a setting of print permission based on a print instruction from the signer;
a transceiver unit for receiving printing data;
a printing data verifying unit for judging whether the digital signature is attached to the printing data, whether the public key of the digital signature is stored in the memory unit when the digital signature is attached, and whether printing based on the print instruction from the signer is permitted when the public key of the digital signature is stored in the memory unit;
a print control unit for permitting printing of the printing data when judged by the printing data verifying unit that the digital signature is attached to the printing data, the public key of the digital signature is stored in the memory unit, and printing based on the print instruction from the signer is permitted, and not permitting printing in other cases; and
a printer unit for printing the printing data given permission to be printed by the print control unit.

2. The print management device according to claim 1, wherein the printing data verifying unit judges that the public key is registered in the memory unit when the digital signature is decrypted by one of the public keys stored in the memory unit and content of the digital signature is legitimate.

3. The print management device according to claim 1, further comprising a notifying unit for notifying a transmission source of the printing data when printing is not permitted.

4. The print management device according to claim 3, wherein the notifying unit also provides notification of a reason that printing is not permitted.

5. The print management device according to claim 1, further comprising a display unit for displaying the fact that printing is not permitted when the print control unit does not permit the printing of the printing data.

6. The print management device according to claim 1, further comprising a setting reception unit for setting information to be stored in the memory unit.

7. A print management device comprising;
means for storing in plurals a public key of a signer of a digital signature in correspondence with a setting of print permission based on a print instruction from the signer;
means for receiving printing data;
means for judging whether the digital signature is attached to the printing data;
means for judging whether the public key of the digital signature is stored in the memory unit when the digital signature is attached;
means for judging whether printing based on the print instruction from the signer is permitted when the public key of the digital signature is stored in the memory unit;
means permitting printing of the printing data, and not permitting the printing in other cases; and
means for printing the printing data given permission to be printed.

8. The print management device according to claim 7, further comprising:
means for decrypting the digital signature using one of the public keys stored in the memory unit; and
means for judging whether content of the decrypted digital signature is legitimate.

9. The print management device according to claim 7, further comprising means for notifying a transmission source of the printing data when printing is not permitted.

10. The print management device according to claim 9, wherein the means for notifying also provides notification of a reason that printing is not permitted.

11. The print management device according to claim 7, further comprising means for displaying the fact that printing is not permitted when the printing of the printing data is not permitted.

12. The print management device according to claim 7, further comprising means for setting a public key and information on print permission to be stored.

13. A print management method comprising the steps of:
receiving printing data;
judging whether a digital signature is attached to the printing data;
judging whether a public key of the digital signature is stored when the digital signature is attached;
permitting printing when the public key of the digital signature is stored and information permitting printing is stored; and
printing the permitted printing data.

14. The print management method according to claim 13, further comprising the steps of:
decrypting the digital signature by one of the stored public keys; and
judging whether content of the digital signature is legitimate.

15. The print management method according to claim 13, further comprising the step of:
notifying a transmission source of the printing data when printing is not permitted.

16. The print management method according to claim 13, further comprising the step of:
providing notification of a reason when printing is not permitted.

17. The print management method according to claim 13 further comprising the step of displaying the fact that printing is not permitted when printing of the printing data is not permitted.
